(19) United States
(12) Patent Application Publication
(10) Pub. No.: US 2021/0243360 A1
(43) Pub. Date: Aug. 5, 2021

(54) INFORMATION PROCESSING DEVICE AND INFORMATION PROCESSING METHOD

(71) Applicant: Sony Corporation, Tokyo (JP)

(72) Inventor: Naoyuki Onoe, Kanagawa (JP)

(73) Assignee: Sony Corporation, Tokyo (JP)

(21) Appl. No.: 17/049,290

(22) PCT Filed: Feb. 1, 2019
(86) PCT No.: PCT/JP2019/003732

§ 371 Date: Oct. 20, 2020

(30) Foreign Application Priority Data
Apr. 27, 2018 (JP) 2018-086363

(51) Int. Cl. H04N 5/232; G06F 3/16; G06F 21/74

(52) U.S. Cl. CPC H04N 5/23219; G06F 21/74; G06F 3/16; H04N 5/23245

(57) ABSTRACT

[Problem] To reduce psychological anxiety of the user regarding acquisition of information in utilizing agent functions.

[Solution] Provided is an information processing device, including a control unit that controls an information acquisition function to acquire information regarding a state of a user, in which the control unit controls a transition to an information protection mode that restricts at least part of the information acquisition function on the basis of a start of a protection target act by the user having been estimated. In addition, there is provided an information processing method, including controlling an information acquisition function by a processor to acquire information regarding a state of a user, in which the controlling further includes controlling a transition to an information protection mode that restricts at least part of the information acquisition function on the basis of a start of a protection target act by the user having been estimated.

[Selected Drawing] FIG. 1

### FIELD

The present disclosure relates to an information processing device and an information processing method.

### BACKGROUND

In recent years, an agent device that provides various functions to a user while interacting with the user has become widespread. Furthermore, a number of technologies for enhancing convenience of a user who uses the agent device have been developed. Patent Literature 1, for example, discloses a technology that reduces a burden on a user regarding interaction with an external agent in a case where the user interacts with a plurality of external agents.

### CITATION LIST

### Patent Literature

Patent Literature 1: JP 2008-90545 A

### SUMMARY

### Technical Problem

Meanwhile, it is assumed that there exists users, among agent device users, who are concerned about whether their voices and/or images that are irrelevant to utilization of functions might be leaked to the outside or acquired more than necessary.

The present disclosure thus proposes a new and improved information processing device and information processing method that are capable of reducing psychological anxiety of a user regarding acquisition of information in utilizing agent functions.

### Solution to Problem

According to the present disclosure, an information processing device is provided that includes: a control unit that controls an information acquisition function to acquire information regarding a state of a user, wherein the control unit controls a transition to an information protection mode that restricts at least part of the information acquisition function on the basis of a start of a protection target act by the user having been estimated.

Moreover, according to the present disclosure, an information processing method is provided that includes: controlling an information acquisition function by a processor to acquire information regarding a state of a user, wherein the controlling further includes controlling a transition to an information protection mode that restricts at least part of the information acquisition function on the basis of a start of a protection target act by the user having been estimated.

### Advantageous Effects of Invention

With the present disclosure, psychological anxiety of the user regarding acquisition of information in utilizing agent functions can be reduced, as described above.

Note that the above-described effect is not necessarily limited, and it is also possible to use any of the effects illustrated in this specification together with the above-described effect or in place of the above-described effect, or other effects that can be assumed from this specification.

### BRIEF DESCRIPTION OF DRAWINGS

FIG. 1 is a diagram for describing an overview of one embodiment of the present disclosure.

FIG. 2 is a diagram for explaining mode control according to the present embodiment.

FIG. 3 is a block diagram illustrating a functional configuration example of an information processing device according to the present embodiment.

FIG. 4 is a flowchart illustrating the flow of transition control to an image protection mode according to the present embodiment.

FIG. 5 is a flowchart illustrating the flow of transition control to an image protection mode according to the present embodiment.

FIG. 6 is a flowchart illustrating the flow of transition control to an image protection mode according to the present embodiment.

FIG. 7 is a flowchart illustrating the flow of return control from the image protection mode to a normal mode according to the present embodiment.

FIG. 8 is a flowchart illustrating the flow of return control from the image protection mode to a normal mode according to the present embodiment.

FIG. 9 is a flowchart illustrating the flow of return control from the image protection mode to a normal mode according to the present embodiment.

FIG. 10 is a flowchart illustrating the flow of transition control to a voice protection mode according to the present embodiment.

FIG. 11 is a flowchart illustrating the flow of transition control to a voice protection mode according to the present embodiment.

FIG. 12 is a flowchart illustrating the flow of transition control to a voice protection mode according to the present embodiment.

FIG. 13 is a flowchart illustrating the flow of return control from the voice protection mode to the normal mode according to the present embodiment.

FIG. 14 is a flowchart illustrating the flow of return control from the voice protection mode to the normal mode according to the present embodiment.

FIG. 15 is a flowchart illustrating the flow of return control from the voice protection mode to the normal mode according to the present embodiment.

FIG. 16 is a diagram illustrating an example of an exhibition regarding execution of the image protection mode according to the present embodiment.

FIG. 17 is a diagram illustrating an example of control in a case where the information processing device according to the present embodiment is an autonomous mobile object.

FIG. 18 is a diagram illustrating an example of an exhibition regarding execution of the voice protection mode according to the present embodiment.

FIG. 19 is a flowchart illustrating the flow of transition control to a positional information protection mode according to the present embodiment.

FIG. 20 is a diagram illustrating examples of restricted contents of an image acquisition function based on an image protection level according to the present embodiment.

FIG. 21 is a diagram illustrating examples of restricted contents of a voice acquisition function based on a voice protection level according to the present embodiment.

FIG. 22 is a diagram illustrating examples of restricted contents of a positional information acquisition function based on a positional information protection level according to the present embodiment.

FIG. 23 is a diagram for explaining switching of a user identification method based on an execution mode according to the present embodiment.

FIG. 24 is a diagram illustrating a hardware configuration example of the information processing device according to an embodiment of the present disclosure.

### DESCRIPTION Of Embodiments

Hereinafter, preferred embodiments of the present disclosure will be described in detail with reference to the accompanying drawings. Note that same reference numerals are given to components having substantially the same functional configuration, and redundant description will be omitted in the present specification and the drawings.

Note that the description will be made in the following order.

1. Embodiment

1.1. Overview

1.2. Functional Configuration Example of Information Processing Device 10

1.3. Details of Mode Control

1.4. User Identification During Execution of Image Protection Mode

2. Exemplary Hardware Configuration

3. Summary

<1. Embodiment>

<<1.1. Overview>>

First, an overview of an embodiment of the present disclosure will be described. In recent years, an agent device that executes various functions while interacting with a user has become widespread, as described above. The agent device as described above is, for example, capable of accepting an inquiry made by an utterance of a user, outputting an answer to the inquiry using a voice and/or visual information, and executing various functions on the basis of an instruction given by an utterance of the user.

Furthermore, some agent devices of recent years provide individually-tailored functions such as management of a schedule for each user by identifying the user on the basis of a captured image.

On the other hand, as described above, it is assumed that there exists users, among agent device users, who are concerned about whether their voices and/or images that are irrelevant to utilization of functions may be leaked to the outside or acquired more than necessary.

In addition, it is expected that not a few users have a sense as if they were monitored in a state where a microphone, a camera, and the like included in the agent device are ON all the time.

The technical idea according to the present disclosure has been established by focusing on the above points, and is capable of reducing psychological anxiety of a user regarding acquisition of information in utilizing agent functions. For this reason, an information processing device 10 that achieves an information processing method according to the present embodiment of the present disclosure includes a control unit 150 that controls an information acquisition function of acquiring information regarding a user state, and one of characteristics of the control unit 150 lies in controlling a transition to an information protection mode that restricts at least part of the information acquisition function on the basis of the start of a protection target act by the user having been estimated.

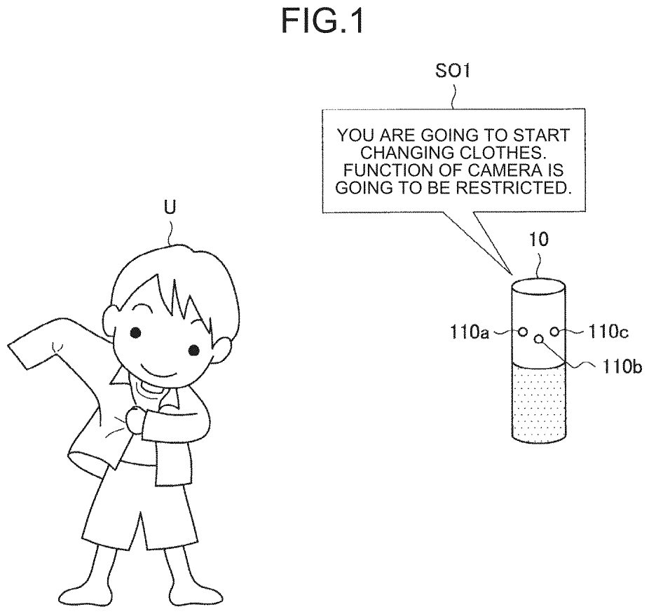

FIG. 1 is a diagram for explaining an overview of the present embodiment. FIG. 1 illustrates a user U and the information processing device 10, which is a stationary agent device to be utilized by the user U.

In an example illustrated in FIG. 1, the information processing device 10 includes, in addition to a microphone (not illustrated), three imaging units 110a to 110c, and actively or passively provides functions to the user U while acquiring a voice and/or image of the user U.

At this time, in a case where the information processing device 10 has estimated the start of the protection target act by the user U from the acquired voice and/or image, the information processing device 10 may restrict at least part of the information acquisition function, i.e., a voice acquisition function and an image acquisition function.

The protection target act described above includes, for example, changing of clothes (dressing and undressing) of the user U. In the example illustrated in FIG. 1, the information processing device 10 performs control such that images regarding an act of changing clothes and/or nudity of the user U are not acquired by estimating the start of the act of changing clothes of the user U from images acquired by the imaging units 110a to 110c and restricting functions of the imaging units 110a to 110c. Furthermore, at this time, the information processing device 10, for example, may notify the user, by a voice utterance SO1 or the like, of a restriction to be imposed on the image acquisition function because the information processing device 10 has estimated the start of the act of changing clothes.

In this manner, with the information processing device 10 according to the present embodiment, privacy and/or security of the user can be protected by estimating the start of the protection target act by the user and restricting acquisition of information regarding the protection target act.

Note that the protection target act according to the present embodiment may include, other than the act of changing clothes described above, a wide range of acts such as an act that the user does not want to be seen and an act that the user does not want to be heard. The information processing device 10, for example, can detect an utterance including subtle information such as a password as a protection target utterance and restrict the voice acquisition function so that a voice regarding the protection target utterance is not acquired.

That is, the information processing device 10 according to the present embodiment can estimate the start of various kinds of the protection target acts by the user on the basis of the acquired image and/or voice, and dynamically switch modes regarding the information acquisition function on the basis of characteristics of the protection target act.

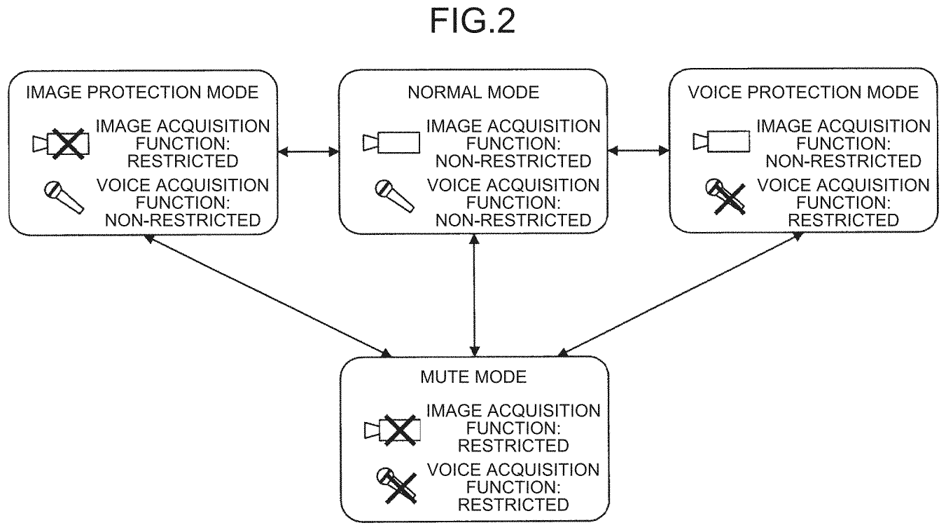

FIG. 2 is a diagram for explaining mode control according to the present embodiment. FIG. 2 illustrates an example of a mode transition in a case where the information processing device 10 according to the present embodiment includes, as the information protection mode, an image protection mode that restricts the image acquisition function, a voice protection mode that restricts the voice acquisition function, and a mute mode that restricts the image acquisition function and the voice acquisition function.

The information processing device 10 according to the present embodiment can protect privacy and/or security of the user and continue to provide various functions in response to the user's needs, for example, by dynamically changing the three information protection modes described above and a normal mode that does not restrict the information acquisition function with the start or end of the protection target act.

The overview of the present embodiment has been described above. Note that the example of the case where the information processing device 10 according to the present embodiment is the stationary agent device has been described in FIG. 1, but the information processing device 10 according to the present embodiment is not limited to the example and can be achieved as various devices. The information processing device 10 according to the present embodiment may be, for example, a smartphone, a tablet, or a personal computer (PC). Furthermore, the information processing device 10 according to the present embodiment may be an autonomous mobile robot or the like.

Furthermore, the information processing device 10 according to the present embodiment may be a server that controls an information processing terminal having the image acquisition function and the voice acquisition function via a network.

<<1.2. Functional Configuration Example of Information Processing Device 10>>

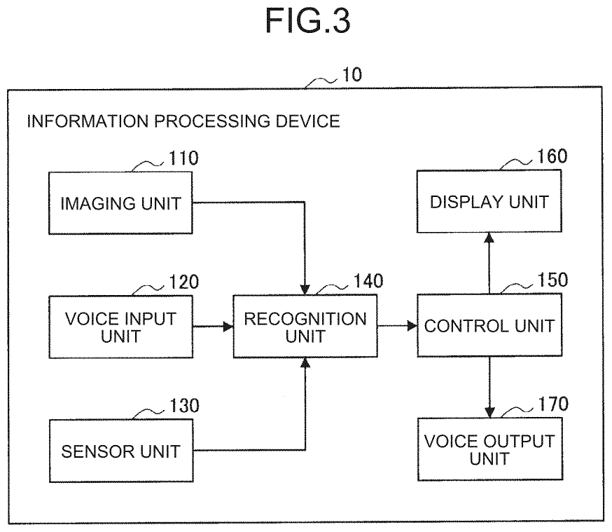

Subsequently, a functional configuration example of the information processing device 10 according to the present embodiment will be described. FIG. 3 is a block diagram illustrating the functional configuration example of the information processing device 10 according to the present embodiment. Referring to FIG. 3, the information processing device 10 according to the present embodiment includes an imaging unit 110, a voice input unit 120, a sensor unit 130, a recognition unit 140, a control unit 150, a display unit 160, and a voice output unit 170.

(Imaging Unit 110)

The imaging unit 110 according to the present embodiment has a function of capturing images of the user and/or surrounding environment. Thus, the imaging unit 110 according to the present embodiment includes an imaging sensor.

(Voice Input Unit 120)

The voice input unit 120 according to the present embodiment has a function of acquiring various sounds including a voice of the user. Thus, the voice input unit 120 according to the present embodiment includes at least one or more microphones.

(Sensor Unit 130)

The sensor unit 130 according to the present embodiment acquires a variety of sensor information regarding the user, the surrounding environment, and the information processing device 10. The sensor unit 130 according to the present embodiment may have, for example, a function of acquiring positional information. Thus, the sensor unit 130 according to the present embodiment includes, for example, a global navigation satellite system (GNSS) signal reception device and/or a wireless signal reception device of various kinds. Furthermore, the sensor unit 130 may include various kinds of optical sensors including a far-infrared sensor, an acceleration sensor, a gyro sensor, a geomagnetic sensor, and the like.

(Recognition Unit 140)

The recognition unit 140 according to the present embodiment executes a variety of recognition processing and estimation processing on the basis of information acquired by the imaging unit 110, the voice input unit 120, and the sensor unit 130.

The recognition unit 140 according to the present embodiment, for example, may have a function of estimating the start or end of the protection target act on the basis of on information regarding the state of the user such as a voice and/or an image.

Furthermore, the recognition unit 140 according to the present embodiment, for example, may have a function of identifying the user on the basis of the image acquired by the imaging unit 110 and/or a function of identifying a speaker on the basis of the voice acquired by the voice input unit 120.

(Control Unit 150)

The control unit 150 according to the present embodiment has a function of controlling the information acquisition function to acquire information regarding the state of the user such as an image, a voice, and positional information. Furthermore, one of characteristics of the control unit 150 according to the present embodiment lies in controlling a transition to the information protection mode that restricts at least part of the information acquisition function on the basis of the start of the protection target act by the user having been estimated by the recognition unit 140.

The control unit 150 according to the present embodiment, for example, may control the information acquisition function such that acquisition accuracy of information regarding the protection target act in the information protection mode is made lower than acquisition accuracy in the normal mode.

More specifically, the control unit 150 according to the present embodiment may decrease the acquisition accuracy of information regarding the protection target act to an extent that at least one of the protection target act or the user cannot be identified in the information protection mode. With the above-described functions of the control unit 150 according to the present embodiment, various functions can be provided to the user using information acquired by a remaining function while privacy and/or security of the user is protected.

Meanwhile, the control unit 150 according to the present embodiment may completely stop the acquisition of the information regarding the protection target act in the information protection mode. In this case, more robustly protecting privacy and/or security of the user can provide a sense of safety to the user.

Furthermore, in a case where the recognition unit 140 has estimated the end of the protection target act by the user, the control unit 150 according to the present embodiment may return to the normal mode that does not restrict the information acquisition function. With the above-described functions of the information processing device 10 according to the present embodiment, dynamically returning to the normal mode in a case where the protection becomes unnecessary can prevent an unnecessary restriction from being imposed on the provision of functions to the user.

In addition, the control unit 150 according to the present embodiment may control various exhibitions regarding execution of the information protection mode in the information protection mode. That is, the control unit 150 according to the present embodiment can provide a further sense of safety to the user by performing control to explicitly or implicitly indicate to the user that the information protection mode is being executed.

Details of the functions of the control unit 150 according to the present embodiment will be described separately.

(Display Unit 160)

The display unit 160 according to the present embodiment has a function of outputting visual information such as images and/or texts. The display unit 160 according to the present embodiment displays information regarding the execution of the information protection mode, for example, on the basis of control by the control unit 150.

Thus, the display unit 160 according to the present embodiment includes a display device or the like that presents visual information. Examples of the display device described above include a liquid crystal display (LCD) device, an organic light emitting diode (OLED) device, and a touch panel. The display unit 160 according to the present embodiment may output visual information by a projection function.

(Voice Output Unit 170)

The voice output unit 170 according to the present embodiment has a function of outputting various sounds including a voice. The voice output unit 170 according to the present embodiment produces an output by a voice that the information protection mode is being executed, for example, on the basis of control by the control unit 150. Thus, the voice output unit 170 according to the present embodiment includes a voice output device such as a speaker and an amplifier.

The functional configuration example of the information processing device 10 according to the present embodiment has been described above. Note that the configuration described above with reference to FIG. 3 is merely an example, and the functional configuration of the information processing device 10 according to the present embodiment is not limited to this example. For example, the information processing device 10 according to the present embodiment does not necessarily include all the constituent elements illustrated in FIG. 3. For example, the information processing device 10 can have, for example, a configuration without the sensor unit 130. Furthermore, the functions of the recognition unit 140 and the control unit 150 according to the present embodiment may be achieved as functions of an information processing server separately arranged from the information processing device 10. In this case, the recognition unit 140 can estimate the start or end of the protection target act on the basis of information received via a network, and furthermore, the control unit 150 can remotely control each constituent element of the information processing device 10 on the basis of a result of the estimation by the recognition unit 140. The functional configuration of the information processing device 10 according to the present embodiment can be flexibly modified in accordance with specifications and/or operations.

<<1.3. Details of Mode Control>>

Subsequently, mode control regarding the information acquisition function by the information processing device 10 according to the present embodiment will be described in detail.

First, a transition from a general circumstance mode to the information protection mode according to the present embodiment will be described with a specific example. As described above, the information protection mode according to the present embodiment may include the image protection mode and/or the voice protection mode.

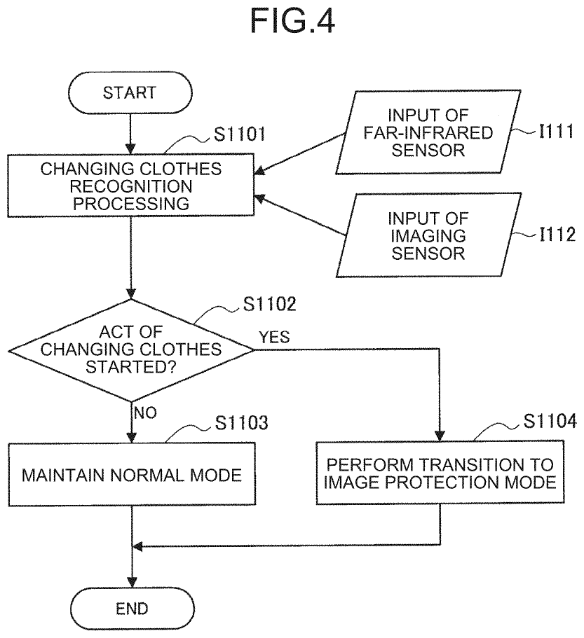

FIGS. 4 to 6 are flowcharts illustrating the flow of transition control to an image protection mode according to the present embodiment. The control unit 150 according to the present embodiment may control a transition to the image protection mode on the basis of the start of the protection target act having been estimated, and control at least part of the image acquisition function in the image protection mode. Note that the protection target act described above includes, for example, an act of changing clothes by the user. The control unit 150 may restrict the image acquisition function to an extent that at least one of the act of changing clothes or the user cannot be identified on the basis of the start of the act of changing clothes having been estimated.

FIG. 4 illustrates a flowchart in a case where the information processing device 10 voluntarily estimates the start of the protection target act on the basis of the acquired information, and automatically performs the transition to the image protection mode. In addition, FIG. 4 illustrates the example in a case where the protection target act is the act of changing clothes of the user.

Referring to FIG. 4, the recognition unit 140 first executes changing clothes recognition processing on the basis of information acquired by the imaging unit 110 and/or the sensor unit 130 (S1101). At this time, the recognition unit 140 may recognize an act of undressing, for example, by detecting change in body surface temperature of the user on the basis of an input of a far-infrared sensor (I111). Furthermore, the recognition unit 140 may recognize the act of undressing, for example, by detecting an increase in flesh color area of the user on the basis of an input of an imaging sensor (I112).

Subsequently, the control unit 150 determines whether or not the start of the act of changing clothes of the user has been estimated in the changing clothes recognition processing in Step S1101 (S1102).

In a case where the start of the act of changing clothes has not been estimated here (S1102: NO), the control unit 150 maintains the normal mode (S1103).

In contrast, in a case where the start of the act of changing clothes has been estimated (S1102: YES), the control unit 150 controls the transition to the image protection mode (S1104).

The voluntary transition control to the image protection mode according to the present embodiment has been described above. Note that in FIG. 4, the description has been given of the example in the case where the recognition unit 140 estimates the start of the protection target act on the basis of the information acquired by the far-infrared sensor and/or the imaging sensor, but the recognition unit 140 according to the present embodiment can estimate the start of the protection target act on the basis of a voice acquired by the microphone. The recognition unit 140, for example, can recognize that the act of changing clothes of a child is about to happen as a context on the basis of an utterance of a mother to the child such as “C, take a bath” and “Change your clothes quickly”.

Subsequently, a description will be given of the flow of control in a case where the information processing device 10 according to the present embodiment performs the transition to the image protection mode on the basis of an instruction of the user.

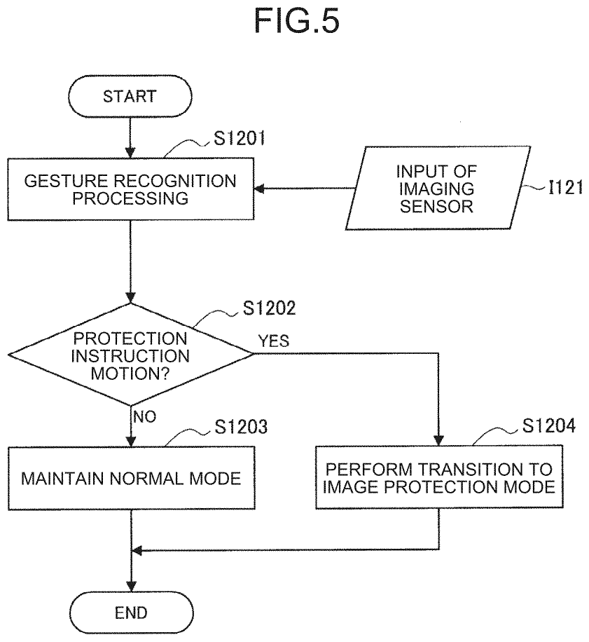

FIG. 5 illustrates the flow in a case where the information processing device 10 according to the present embodiment performs the transition to the image protection mode on the basis of an instruction using a gesture.

Referring to FIG. 5, the recognition unit 140 first executes gesture recognition processing on the basis of an input of the imaging sensor (I121) or the like (S1201).

Subsequently, the control unit 150 determines whether or not a protection instruction motion, which is a gesture to instruct the transition to the image protection mode, has been recognized in Step S1201 (S1202). The protection instruction motion described above may be, for example, such a gesture of the user as to cover his/her own eyes with his/her hands and such a gesture as to cover the imaging unit 110 of the information processing device 10 with his/her hands.

In a case where the protection instruction motion has not been recognized here (S1202: NO), the control unit 150 maintains the normal mode (S1203).

In contrast, in a case where the protection instruction motion has been recognized (S1202: YES), the control unit 150 controls the transition to the image protection mode (S1204).

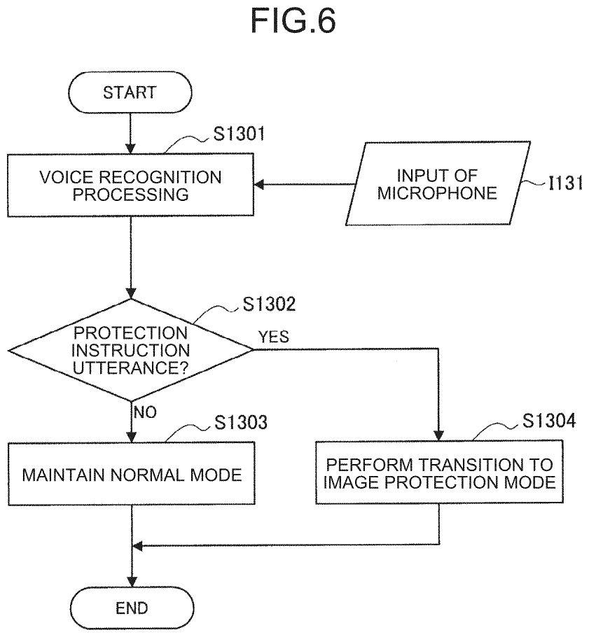

Furthermore, a user instruction according to the present embodiment may be given by an utterance. FIG. 6 illustrates the flow in a case where the information processing device 10 according to the present embodiment performs the transition to the image protection mode on the basis of the instruction by the utterance of the user.

Referring to FIG. 6, the recognition unit 140 first executes voice recognition processing on the basis of an input of the microphone (I131) (S1301).

Subsequently, the control unit 150 determines whether or not a protection instruction utterance to instruct the transition to the image protection mode has been recognized in Step S1301 (S1302). The protection instruction utterance described above may be, for example, utterances of “Camera, OFF”, “Don't look”, and “I'm going to change clothes”.

In a case where the protection instruction utterance has not been recognized here (S1302: NO), the control unit 150 maintains the normal mode (S1303).

In contrast, in a case where the protection instruction utterance has been recognized (S1302: YES), the control unit 150 controls the transition to the image protection mode (S1304).

The flow of the transition control to the image protection mode according to the present embodiment has been described above. Note that the example of the case where the instruction of the user is given by a gesture and/or a voice has been described above, but the control unit 150 according to the present embodiment may perform the transition control to the image protection mode on the basis of the user instruction, for example, via various buttons included in the information processing device 10, an external device such as a smartphone, or an application.

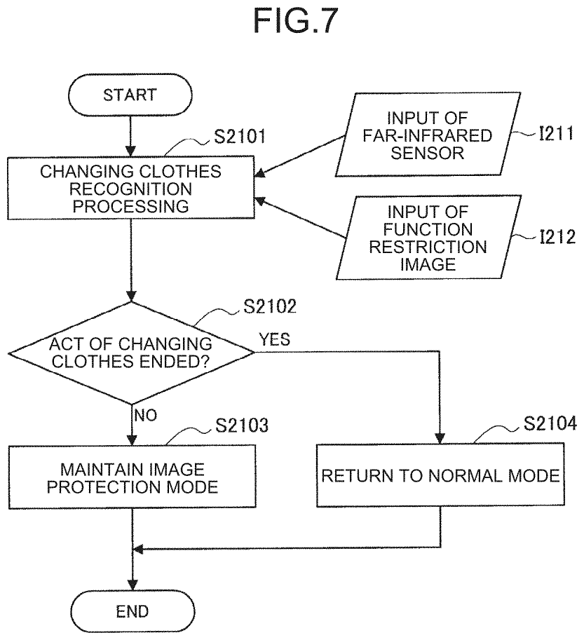

Subsequently, the flow of return control from the image protection mode to the normal mode according to the present embodiment will be described. FIGS. 7 to 9 are flowcharts each illustrating the return control from the image protection mode to the normal mode according to the present embodiment.

FIG. 7 illustrates a flowchart in a case where the information processing device 10 voluntarily estimates the end of the protection target act of the user on the basis of the acquired information, and automatically performs the return control from the image protection mode to the normal mode. In addition, FIG. 7 illustrates the example in a case where the protection target act is the act of changing clothes of the user.

Referring to FIG. 7, the recognition unit 140 first executes the changing clothes recognition processing (S2101) on the basis of on an input of the far-infrared sensor (I211) and/or an input of a function restriction image (I212). The function restriction image here may be an image acquired by the remaining function of the image acquisition function that is restricted in the image protection mode. Examples of the function restriction image include a blurred image captured in an out-of-focus state. In this manner, in the image protection mode according to the present embodiment, the function restriction image that protects privacy and/or security of the user may be acquired by restricting part of the image acquisition function of the imaging unit 110 without completely stopping the image acquisition function.

Furthermore, the control unit 150 according to the present embodiment may cause the imaging unit 110 to acquire only detection information of a person and/or a moving object in the image protection mode. In this case, the recognition unit 140 can detect that the user has disappeared from a surrounding area of the information processing device 10 or the like on the basis of the detection information described above. In this manner, the recognition unit 140 according to the present embodiment can estimate the end of the protection target act in the information protection mode on the basis of the information acquired by the remaining function of the restricted information acquisition function.

Subsequently, the control unit 150 determines whether or not the end of the act of changing clothes of the user has been estimated in the changing clothes recognition processing in Step S2101 (S2102).

In a case where the end of the act of changing clothes has not been estimated here (S2102: NO), the control unit 150 maintains the image protection mode (S2103).

In contrast, in a case where the end of the act of changing clothes has been estimated (S2102: YES), the control unit 150 controls the return to the normal mode (S2104).

The voluntary transition control from the image protection mode to the normal mode according to the present embodiment has been described above. Note that in FIG. 7, the description has been given of the example in the case where the recognition unit 140 estimates the end of the protection target act on the basis of the information acquired by the far-infrared sensor and/or the imaging sensor through the remaining function, but the recognition unit 140 according to the present embodiment can estimate the end of the protection target act on the basis of a voice acquired by the microphone. The recognition unit 140 can recognize that the act of changing clothes of the child has ended as a context, for example, on the basis of an utterance of the mother to the child such as “C, you could change your clothes”.

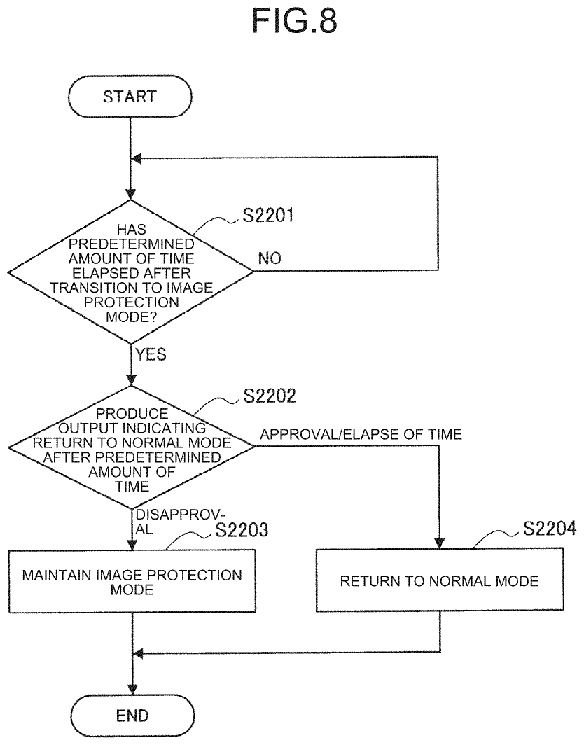

Subsequently, a description will be given of the flow of control in a case where the information processing device 10 according to the present embodiment returns from the image protection mode to the normal mode on the basis of the elapse of a predetermined amount of time. FIG. 8 illustrates the flow in a case where the information processing device 10 according to the present embodiment returns from the image protection mode to the normal mode on the basis of the elapse of the predetermined amount of time.

Referring to FIG. 8, the control unit 150 determines whether or not the predetermined amount of time has elapsed after the transition to the image protection mode (S2201).

In a case where the predetermined amount of time has not elapsed here (S2201: NO), the control unit 150 returns to Step S2201, and repeatedly executes the determination described above.

In contrast, in a case where the predetermined amount of time has elapsed (S2201: YES), the control unit 150 performs control to produce an output indicating a return to the normal mode by a voice and/or visual information after a predetermined amount of time (e.g., after ten seconds) (S2202).

In a case where the user expresses his/her intention of disapproval (S2202: disapproval), the control unit 150 maintains the image protection mode (S2203).

In contrast, in a case where the user expresses his/her intention of approval or in a case where the predetermined amount of time has elapsed (S2202: approval/elapse of time), the control unit 150 returns to the normal mode (S2204).

Subsequently, a description will be given of the flow of control in a case where the information processing device 10 according to the present embodiment returns from the image protection mode to the normal mode on the basis of the instruction of the user.

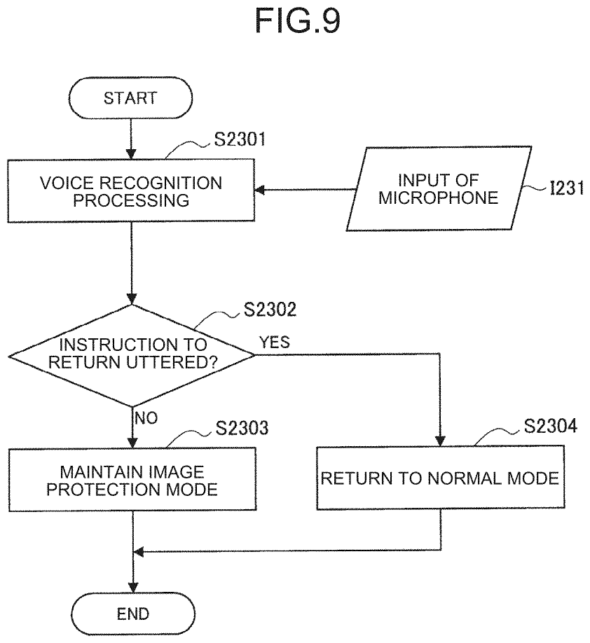

FIG. 9 illustrates the flow in a case where the information processing device 10 according to the present embodiment returns from the image protection mode to the normal mode on the basis of the instruction of the user.

Referring to FIG. 9, the recognition unit 140 first executes voice recognition processing (S2301) on the basis of an input of the microphone (I231). At this time, the recognition unit 140 can recognize an utterance such as “Camera, ON”, “Normal mode”, “You may look”, and “Done”, as an utterance regarding an instruction to return to the normal mode.

Subsequently, the control unit 150 determines whether or not the instruction to return to the normal mode has been recognized in Step S230 (S2302).

In a case where the instruction to return has not been recognized here (S2302: NO), the control unit 150 maintains the image protection mode (S2303).

In contrast, in a case where the instruction to return has been recognized (S2302: YES), the control unit 150 controls the return to the normal mode (S2304).

The flow of the return control from the image protection mode to the normal mode according to the present embodiment has been described above. Note that the example of the case where the instruction of the user is given by the utterance has been described above, but the control unit 150 according to the present embodiment may perform the return control to the normal mode, for example, on the basis of the user instruction via various buttons included in the information processing device 10, an external device such as a smartphone, or an application. Further, the recognition unit 140 according to the present embodiment, for example, can recognize the instruction given by a gesture of the user on the basis of the input of the far-infrared sensor and/or the blurred image described above.

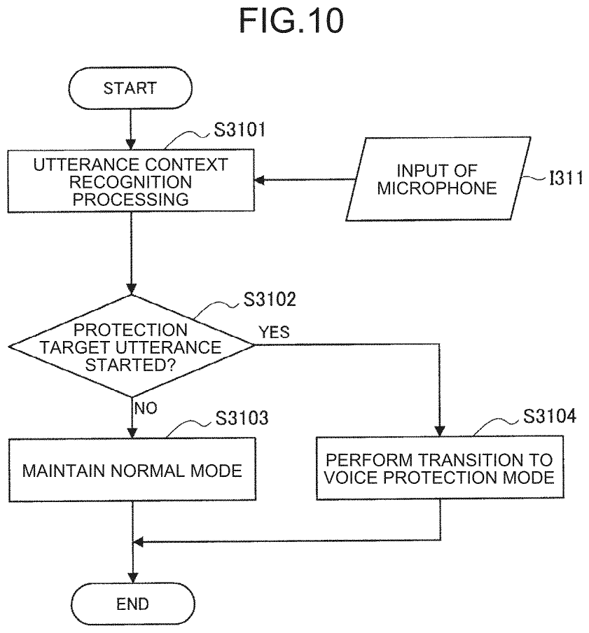

The flow of the transition control to the voice protection mode according to the present embodiment will be described in detail below. FIGS. 10 to 12 are flowcharts illustrating the flow of transition control to a voice protection mode according to the present embodiment. The control unit 150 according to the present embodiment may control a transition to the voice protection mode on the basis of the start of the protection target act having been estimated, and control at least part of the voice acquisition function in the voice protection mode. Note that the protection target act described above includes, for example, the protection target utterance by the user. The control unit 150 may restrict the voice acquisition function to an extent that a content of the protection target utterance cannot be identified on the basis of the start of the protection target utterance having been estimated.

FIG. 10 illustrates a flowchart in a case where the information processing device 10 voluntarily estimates the start of the protection target utterance of the user on the basis of the acquired information, and automatically performs the transition to the voice protection mode. In this manner, the protection target act according to the present embodiment may include the protection target utterance by the user. The protection target utterance according to the present embodiment includes a wide range of utterances that the user supposedly does not want to be heard. Examples of the utterance include personal information and classified information.

Referring to FIG. 10, the recognition unit 140 first executes utterance context recognition processing (S3101) on the basis of an input of the microphone (I311). At this time, the recognition unit 140 can estimate the start of the protection target utterance of the user by recognizing an utterance context such as “What is a password?”, and “Between you and me”.

Subsequently, the control unit 150 determines whether or not the start of the protection target utterance has been estimated in the utterance context recognition processing in Step S3101 (S3102).

In a case where the start of the protection target utterance has been not estimated here (S3102: NO), the control unit 150 maintains the normal mode (S3103).

In contrast, in a case where the start of the protection target utterance has been estimated (S3102: YES), the control unit 150 controls the transition to the voice protection mode (S3104).

The voluntary transition control to the voice protection mode according to the present embodiment has been described above. Subsequently, a description will be given of the flow of control in a case where the information processing device 10 according to the present embodiment performs the transition to the voice protection mode on the basis of an instruction of the user.

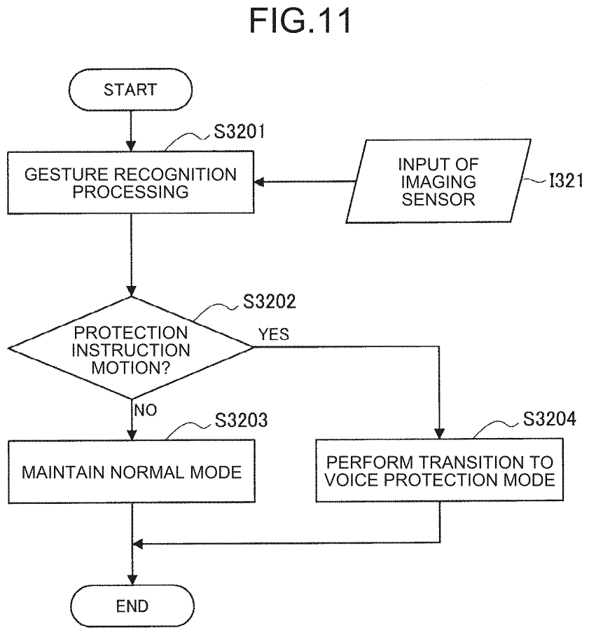

FIG. 11 illustrates the flow in a case where the information processing device 10 according to the present embodiment performs the transition to the voice protection mode on the basis of an instruction using a gesture.

Referring to FIG. 11, the recognition unit 140 first executes gesture recognition processing on the basis of an input of the imaging sensor (I321) or the like (S3201).

Subsequently, the control unit 150 determines whether or not a protection instruction motion, which is a gesture to instruct the transition to the voice protection mode, has been recognized in Step S3201 (S3202). The protection instruction motion described above may be, for example, such a gesture of the user as to cover his/her own ears with his/her hands, such a gesture of the user as to touch his/her own mouth with his/her fingers, and such a gesture as to cover the voice input unit 120 of the information processing device 10 with his/her hands.

In a case where the protection instruction motion has not been recognized here (S3202: NO), the control unit 150 maintains the normal mode (S3203).

In contrast, in a case where the protection instruction motion has been recognized (S3202: YES), the control unit 150 controls the transition to the voice protection mode (S3204).

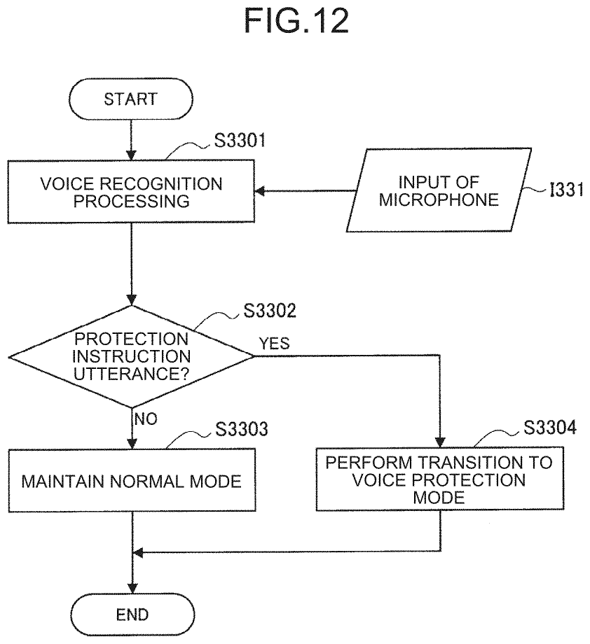

Furthermore, a user instruction according to the present embodiment may be given by an utterance. FIG. 12 illustrates the flow in a case where the information processing device 10 according to the present embodiment performs the transition to the voice protection mode on the basis of the instruction by the utterance of the user.

Referring to FIG. 12, the recognition unit 140 first executes voice recognition processing on the basis of an input of the microphone (I331) (S3301).

Subsequently, the control unit 150 determines whether or not the protection instruction utterance to instruct the transition to the voice protection mode has been recognized in Step S3301 (S3302). The protection instruction utterance described above may be, for example, utterances of “Microphone, OFF”, “Don't hear”, and “Privacy mode”.

In a case where the protection instruction utterance has not been recognized here (S3302: NO), the control unit 150 maintains the normal mode (S3303).

In contrast, in a case where the protection instruction utterance has been recognized (S3302: YES), the control unit 150 controls the transition to the voice protection mode (S3304).

The flow of the transition control to the voice protection mode according to the present embodiment has been described above. Note that the example of the case where the instruction of the user is given by a gesture and/or a voice has been described above, but the control unit 150 according to the present embodiment may perform the transition control to the voice protection mode on the basis of the user instruction, for example, via various buttons included in the information processing device 10, an external device such as a smartphone, or an application.

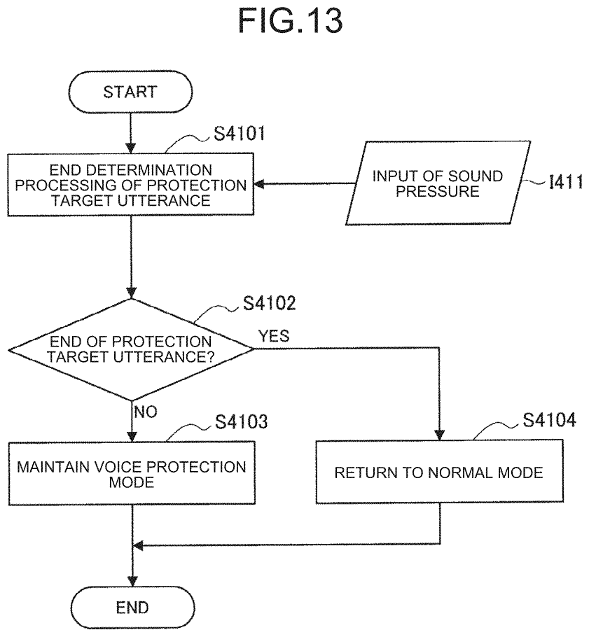

Subsequently, the flow of return control from the voice protection mode to the normal mode according to the present embodiment will be described. FIGS. 13 to 15 are flowcharts each illustrating the return control from the voice protection mode to the normal mode according to the present embodiment.

FIG. 13 illustrates a flowchart in a case where the information processing device 10 voluntarily estimates the end of the protection target act of the user on the basis of the acquired information, and automatically performs the return control from the voice protection mode to the normal mode.

Referring to FIG. 13, the recognition unit 140 first executes end determination processing of the protection target utterance (S4101) on the basis of an input of sound pressure (I411). Here, the sound pressure described above may be information regarding a sound pressure level (volume) in accordance with the utterance of the user acquired by a remaining function of the voice acquisition function that is restricted in the voice protection mode. In this manner, in the voice protection mode according to the present embodiment, information may be acquired so as to protect privacy and/or security of the user by restricting part of the voice acquisition function of the voice input unit 120 without completely stopping the voice acquisition function. In this case, the recognition unit 140 can estimate the end of the protection target utterance, for example, in a case where sound pressure decreases for a predetermined amount of time or more.

Furthermore, the recognition unit 140 may execute the end determination processing of the protection target utterance on the basis of image recognition. The recognition unit 140 can determine the end of the protection target utterance, for example, on the basis of a plurality of users who has had a conversation not facing each other anymore, the user facing the direction of the information processing device 10, and/or the user's mouth not moving any more.

Subsequently, the control unit 150 determines whether or not the end of the protection target utterance has been estimated in Step S4101 (S4102).

In a case where the end of the protection target utterance has not been estimated here (S4102: NO), the control unit 150 maintains the voice protection mode (S4103).

In contrast, in a case where the protection target utterance has been estimated (S4102: YES), the control unit 150 controls the return to the normal mode (S4104).

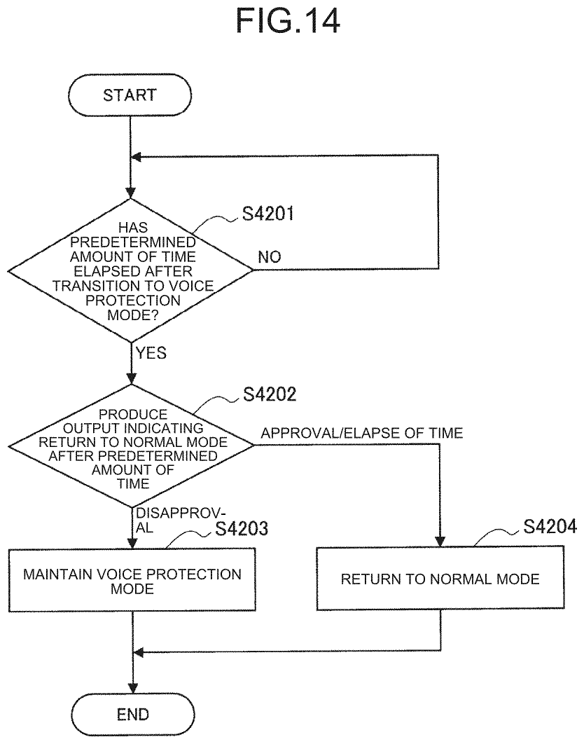

The voluntary transition control from the voice protection mode to the normal mode according to the present embodiment has been described above. Subsequently, a description will be given of the flow of control in a case where the information processing device 10 according to the present embodiment returns from the voice protection mode to the normal mode on the basis of the elapse of a predetermined amount of time. FIG. 14 illustrates the flow in a case where the information processing device 10 according to the present embodiment returns from the voice protection mode to the normal mode on the basis of the elapse of the predetermined amount of time.

Referring to FIG. 14, the control unit 150 determines whether or not the predetermined amount of time has elapsed after the transition to the voice protection mode (S4201).

In a case where the predetermined amount of time has not elapsed here (S4201: NO), the control unit 150 returns to Step S4201, and repeatedly executes the determination described above.

In contrast, in a case where the predetermined amount of time has elapsed (S4201: YES), the control unit 150 performs control to produce an output indicating a return to the normal mode by a voice and/or visual information after a predetermined amount of time (e.g., after ten seconds) (S4202).

In a case where the user expresses his/her intention of disapproval (S4202: disapproval), the control unit 150 maintains the voice protection mode (S4203).

In contrast, in a case where the user expresses his/her intention of approval or in a case where the predetermined amount of time has elapsed (S4202: approval/elapse of time), the control unit 150 returns to the normal mode (S4204).

Subsequently, a description will be given of the flow of control in a case where the information processing device 10 according to the present embodiment returns from the voice protection mode to the normal mode on the basis of the instruction of the user.

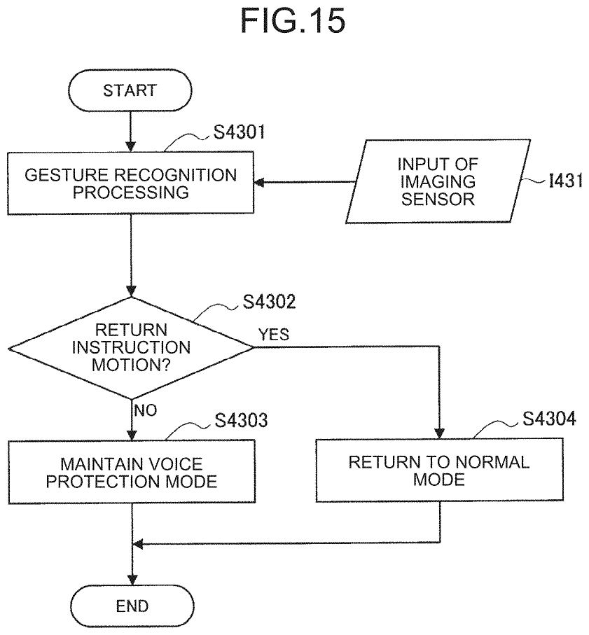

FIG. 15 illustrates the flow in a case where the information processing device 10 according to the present embodiment returns from the voice protection mode to the normal mode on the basis of the instruction of the user.

Referring to FIG. 15, the recognition unit 140 first executes gesture recognition processing on the basis of an input of the imaging sensor (I431) (S4301).

Subsequently, the control unit 150 determines whether or not or not a return instruction motion to instruct a return to the normal mode has been recognized in Step S430 (S4302). The return instruction motion described above may be, for example, such a gesture as to make a circle by an arm or a finger, and such a gesture as to point an ear with the finger.

In a case where the return instruction motion has not been recognized here (S4302: NO), the control unit 150 maintains the voice protection mode (S4303).

In contrast, in a case where the return instruction motion has been recognized (S4302: YES), the control unit 150 controls the return to the normal mode (S4304).

The flow of the return control from the voice protection mode to the normal mode according to the present embodiment has been described above. Note that the example of the case where the instruction of the user is given by a gesture has been described above, but the control unit 150 according to the present embodiment may perform the return control to the normal mode on the basis of the user instruction, for example, via various buttons included in the information processing device 10, an external device such as a smartphone, or an application.

The flow of the mode control according to the present embodiment has been described above. Subsequently, variations of the control in the image protection mode and the voice protection mode will be described. As described above, in the information protection mode, the control unit 150 according to the present embodiment can achieve, other than the control of completely stopping the information acquisition function, protection of privacy and/or security, continuation of provision of functions, and the return to the normal mode by restricting part of the information acquisition function.

In the image protection mode, the control unit 150, for example, may physically close only a shutter of an imaging unit 110 that captures an image in a direction in which the protection target act is estimated among a plurality of imaging units 110, or may stop only a function of the imaging unit 110 that captures an image in the above-described direction to turn OFF a tally light.

Furthermore, the control unit 150 may control the imaging unit 110 to acquire a blurred image as described above. At this time, the control unit 150 may cause all the imaging units 110 to acquire blurred images, or may cause only the imaging unit 110 that captures an image in the direction in which the protection target act is estimated to acquire a blurred image.

Furthermore, in a case where image recognition processing is executed by the imaging unit 110, the control unit 150 may control the imaging unit 110 to output only a recognition result. In this case, even if a third person attempts to do unauthorized acquisition of an image via the network, the image remains in the imaging unit 110 so that security can be further enhanced.

Furthermore, the control unit 150 according to the present embodiment may have a function of exhibiting that the information protection mode is being executed using various methods. With the above-described functions of the control unit 150 according to the present embodiment, the user can grasp that the information protection mode is being executed and have a further sense of safety.

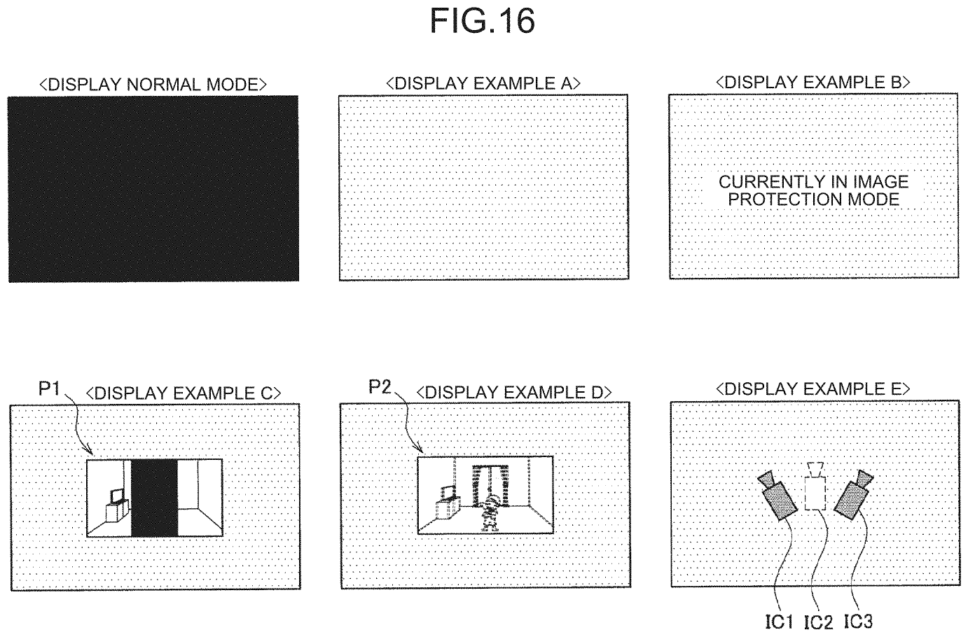

FIG. 16 is a diagram illustrating examples of exhibitions regarding execution of the image protection mode according to the present embodiment. FIG. 16 illustrates examples in a case where the display unit 160 projects visual information by the projection function.

The control unit 150, for example, may perform projection on the display unit 160 by setting a background color to black in the normal mode. In this case, the control unit 150 may indicate to the user that the image protection mode is being executed by setting the background color in the image protection mode to a color different from that in the normal mode, as illustrated as Display Example A.

Furthermore, the control unit 150, for example, may cause the display unit 160 to explicitly display texts indicating that the image protection mode is being executed, as illustrated in Display Example B. In addition, the control unit 150 may cause the voice output unit 170 to output the texts described above as a voice.

Furthermore, the control unit 150, for example, may cause the display unit 160 to display an image P1 acquired by restricting the imaging in a partial area, as illustrated in Display Example C. FIG. 16 illustrates an example of an image acquired in a case where the control unit 150 closes a shutter of the imaging unit 110b, among the imaging units 110a to 110c.

Furthermore, the control unit 150, for example, may cause the display unit 160 to display a blurred image P2 acquired by imposing a functional restriction, as illustrated in Display Example D.

Furthermore, the control unit 150, for example, may indicate presence/absence of the functional restriction regarding the plurality of imaging units 110 by icons, as illustrated in Display Example E. FIG. 16 illustrates an example in a case where icons IC1 to IC3 correspond to the imaging units 110a to 110c, respectively, and the control unit 150 restricts a function of the imaging unit 110b.

The variations of the control in the image protection mode according to the present embodiment has been described above. Note that the case where the information processing device 10 according to the present embodiment is the stationary agent device has been described as the main example, but the information processing device 10 according to the present embodiment may be, for example, an autonomous mobile robot. In this case, the information processing device 10 according to the present embodiment may perform a variety of control with physical motions in the image protection mode.

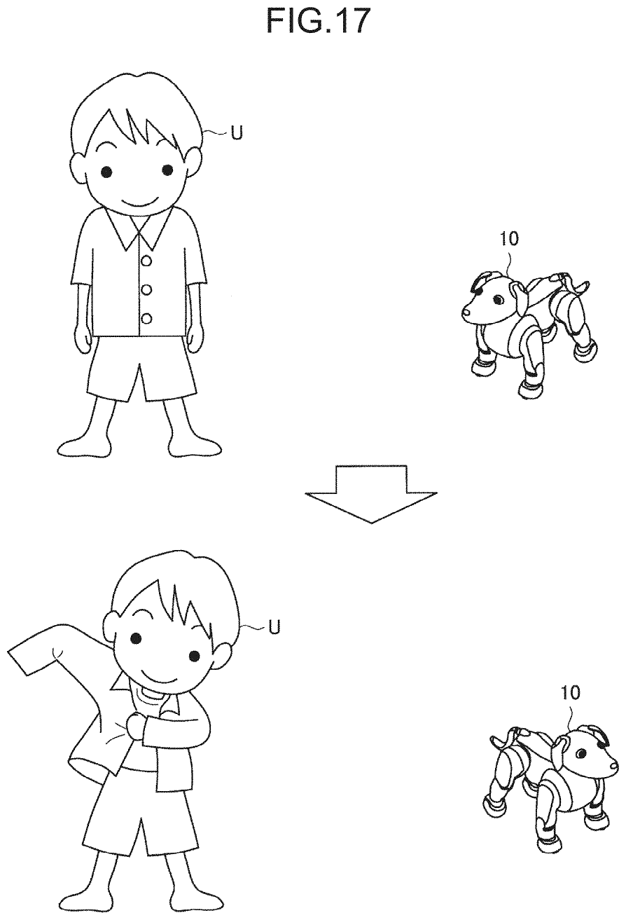

FIG. 17 is a diagram illustrating an example of control in a case where the information processing device 10 according to the present embodiment is the autonomous mobile object. The upper part of FIG. 17 illustrates the information processing device 10, which is a dog-type robot, and the user U in a normal state (state of not performing protection target act).

In contrast, the lower part of FIG. 17 illustrates the user performing the act of changing clothes, which is the protection target act. At this time, the information processing device 10 according to the present embodiment, for example, may turn its eyes away from the user, i.e., operate such that the user U becomes not included in an angle of view of the imaging unit 110, as illustrated in FIG. 17.

Furthermore, in a case where the act of changing clothes by the user U has been estimated, the information processing device 10, for example, may operate so as not to acquire an image regarding the act of changing clothes of the user by covering the eyes (imaging unit 110) with its hands.

In this manner, the information processing device 10 according to the present embodiment may achieve protection of privacy and/or security and express that the information protection mode is being executed by the physical motions in the information protection mode.

Subsequently, variations of the control in the voice protection mode according to the present embodiment will be described.

The control unit 150, for example, may perform control of physically closing a hole connecting the microphone and the outside in the voice protection mode. Furthermore, the control unit 150, for example, may perform control of stopping a function of the microphone and turning OFF the tally light.

Furthermore, the control unit 150, for example, may perform control of performing filtering processing such as reverberation on acquired voice waveform data. Furthermore, the control unit 150 may perform control the voice input unit 120 to output only a recognition result of sound pressure and/or an inter-utterance interval.

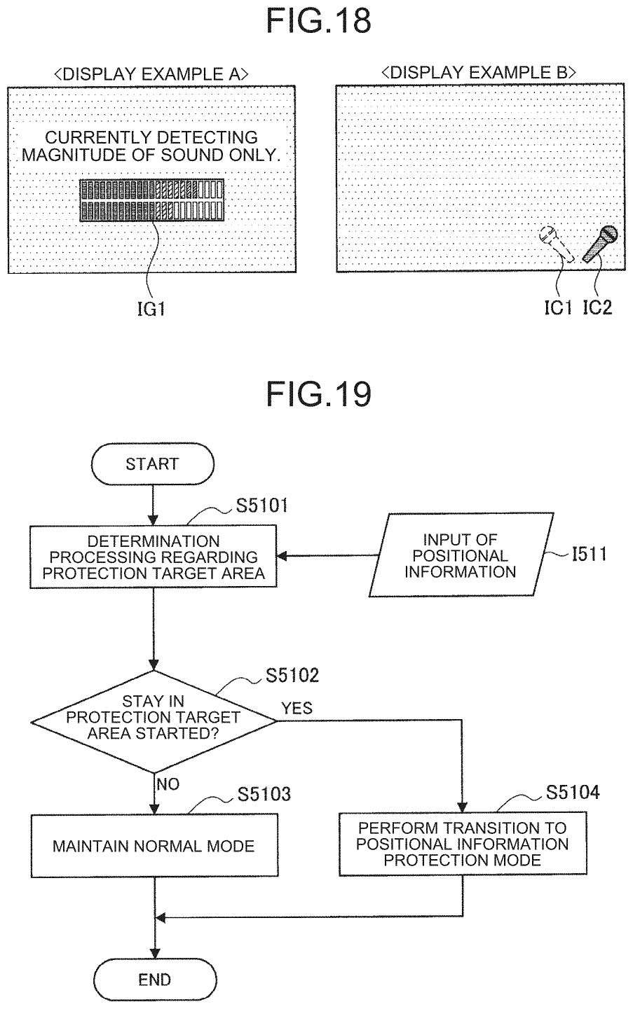

Subsequently, an example of an exhibition regarding execution of the voice protection mode according to the present embodiment will be described. FIG. 18 is a diagram illustrating an exhibition regarding execution of the voice protection mode according to the present embodiment.

The control unit 150, for example, may indicate to the user that the voice protection mode is being executed by setting the background color in the voice protection mode to a color different from that in the normal mode, in a similar manner to the case of the image protection mode.

Furthermore, the control unit 150, for example, may cause the display unit 160 to display texts indicating that the voice protection mode is being executed, as illustrated in Display Example A. In FIG. 18, the display unit 160 displays that only the sound pressure is being acquired. In addition, in a case where only the sound pressure is acquired, the control unit 150 may indicate to the user a magnitude of the sound pressure being acquired by using an indicator IG1 illustrated in FIG. 18.

Furthermore, the control unit 150, for example, may indicate presence/absence of the functional restriction regarding the plurality of voice input units 120 by icons, as illustrated in Display Example B. FIG. 18 illustrates an example in a case where icons IC1 and IC2 corresponding to the voice input units 120a and 120b, respectively, and the control unit 150 restricts a function of the voice input unit 120a.

The control in the image protection mode and the voice protection mode according to the present embodiment has been described in detail above. Meanwhile, the information protection mode according to the present embodiment may include the positional information protection mode other than the image protection mode and the voice protection mode.

In a case where the information processing device 10 is, for example, the user's smartphone, tablet, or the like, it is assumed that the information processing device 10 acquires positional information regarding a location of the user and uses the positional information to various functions.

However, there may be a case where the positional information described above may be recognized as information that is not desired to be known to the outside depending on a user. Furthermore, this is not limited to the user side, and a case is also assumed where the positional information is not desired to be acquired by users who visit a predetermined location, for example, from the viewpoint of confidentiality of a company or an organization.

Thus, the control unit 150 according to the present embodiment may control a transition to the positional information protection mode and restrict at least part of a positional information acquisition function in a case where a location as described above has been acquired as a protection target area and a stay of the user in the protection target area has been estimated. At this time, the control unit 150 may completely stop the positional information acquisition function, or may restrict the positional information acquisition function to an extent that the protection target area cannot be identified.

FIG. 19 is a flowchart illustrating the flow of transition control to the positional information protection mode according to the present embodiment. Referring to FIG. 19, the recognition unit 140 first executes determination processing regarding the protection target area (S5101) on the basis of an input of positional information (I511). At this time, the recognition unit 140, for example, may estimate the start of the stay of the user in the protection target area in a case where a distance between a position of the protection target area and a present position is less than a predetermined distance. Note that the recognition unit 140 may set the protection target area on the basis of an explicit instruction of the user, or may set the protection target area on the basis of an utterance such as “The business trip destination tomorrow is a top secret”. Furthermore, the recognition unit 140 may set an area in which acquisition of the positional information is prohibited by a corporation, an organization, or the like, as the protection target area.

Subsequently, the control unit 150 determines whether or not the stay of the user in the protection target area has been estimated in Step S5102 (S5102).

In a case where the stay of the user in the protection target area has not been estimated here (S5102: NO), the control unit 150 maintains the normal mode (S5103).

In contrast, in a case where the stay of the user in the protection target area has been estimated (S5102: YES), the control unit 150 controls the transition to the positional information protection mode (S5104).

The flow of the transition control to the positional information protection mode according to the present embodiment has been described above. Note that in a case where an exit of the user from the protection target area has been estimated on the basis of an image and/or a voice or in a case where there is an explicit instruction of the user, the control unit 150 may perform return control from the positional information protection mode to the normal mode. The recognition unit 140, for example, may recognize that the user has gone home on the basis of an image and estimate the end of the stay of the user in the protection target area. Furthermore, the recognition unit 140, for example, may estimate the end of the stay of the user in the protection target area on the basis of an utterance, such as “Business trip is over” and “I'm back”.

The positional information protection mode according to the present embodiment has been described above. Subsequently, control based on a protection level of the protection target act according to the present embodiment will be described. The variety of control performed by the control unit 150 according to the present embodiment in the information protection mode has been described above.

At this time, the control unit 150 according to the present embodiment, for example, may determine a restricted content of the information acquisition function on the basis of the protection level of the protection target act.

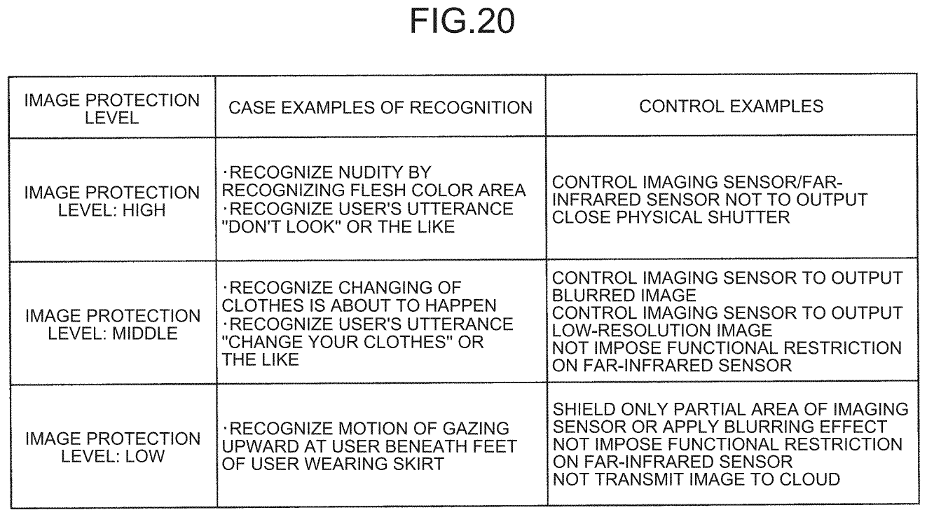

FIG. 20 is a diagram illustrating examples of restricted contents of an image acquisition function based on an image protection level according to the present embodiment. Referring to FIG. 20, in a case where, for example, nudity of the user has been estimated by recognition of the flesh color area or there is an explicit instruction of the user, the control unit 150 may perform control to bring the image protection level into a high level and cause the imaging sensor and/or the far-infrared sensor not to produce an output. Furthermore, the control unit 150 may control to close a physical shutter with the image protection level being the high level.

Furthermore, in a case where, for example, the start of the act of changing clothes has been estimated by recognition of the changing of clothes or an utterance such as “Change your clothes” has been recognized, the control unit 150 may perform control to bring the image protection level into a middle level and cause the imaging sensor to output only a blurred image or a low-resolution image. In addition, the control unit 150 need not impose a functional restriction on the far-infrared sensor with the image protection level being at the middle level.

Furthermore, in a case where, for example, the information processing device 10 is an autonomous mobile robot and the information processing device 10 recognizes a motion of gazing upward at the user beneath the feet of the user who wears a skirt, the control unit 150 may perform control to bring the image protection level into a low level and cause only a partial area of the imaging sensor to be shielded, apply a blurring effect, and the like. Moreover, the control unit 150 need not impose a functional restriction on the far-infrared sensor with the image protection level being at the low level. In addition, the control unit 150 performs control not to transmit an image to an external device or the like installed on a cloud with the image protection level being at the low level.

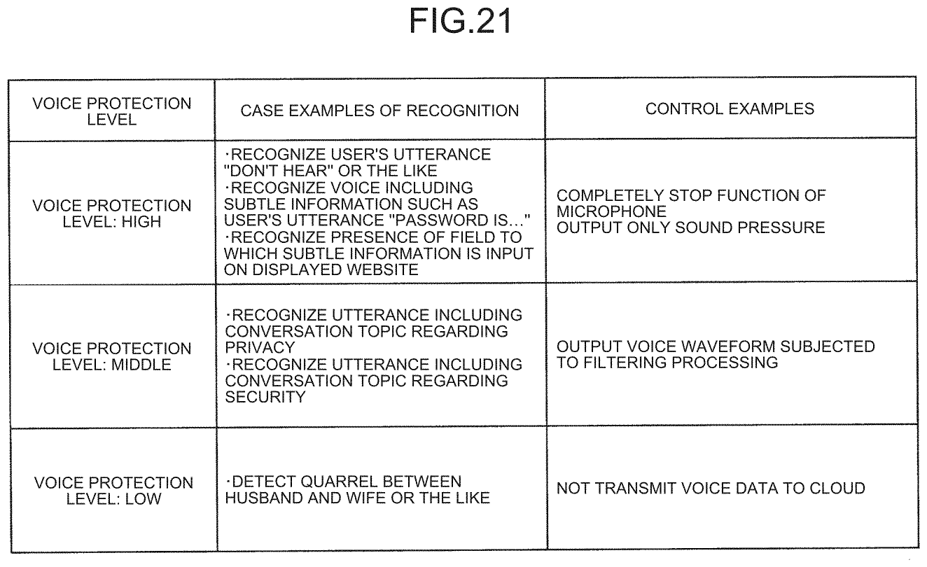

FIG. 21 is a diagram illustrating examples of restricted contents of a voice acquisition function based on a voice protection level according to the present embodiment. Referring to FIG. 21, for example, in a case where there is an explicit instruction of the user, in a case where an utterance including subtle information such as a password has been recognized, or in a case where there is a field to which the subtle information is input on a website or the like displayed on the display unit 160, the control unit 150 may perform control to bring the image protection level into the high level, and completely stop the function of the microphone or acquire only the sound pressure.

Furthermore, in a case where an utterance including a conversation topic regarding a private matter and/or security has been recognized, the control unit 150 may perform control to bring the voice protection level into the middle level and perform filtering processing on an acquired voice waveform. The conversation topic regarding the private matter may include, for example, a conversation topic regarding friendship such as “D and E do not like each other” and “E appears to like F”. In addition, the conversation topic regarding security described above may include, for example, a conversation topic regarding information for internal use only, a salary, a deposit amount, and the like.

Furthermore, in such a case where a quarrel between a husband and wife or the like has been recognized, the control unit 150 may perform control to bring the voice protection level into the low level and control such that an acquired voice is not transmitted to an external device installed on a cloud.

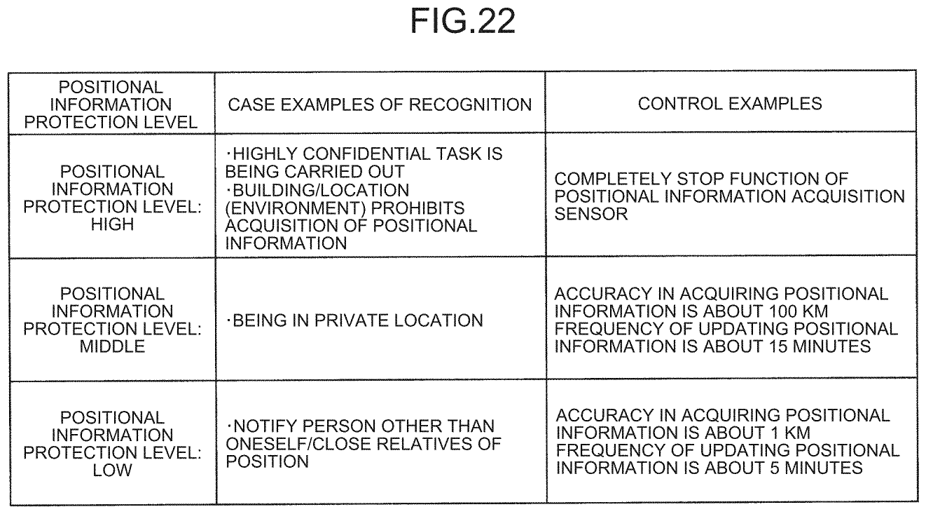

FIG. 22 is a diagram illustrating examples of restricted contents of a positional information acquisition function based on a positional information protection level according to the present embodiment. Referring to FIG. 22, in a case where, for example, the user being carrying out a highly confidential task has been estimated or acquisition of positional information is prohibited by an environment such as a building and a location, the control unit 150 may perform control to bring the positional information protection level into the high level, and completely stop a function of a positional information acquisition sensor such as a global navigation satellite system (GNSS) signal reception device.

Furthermore, in a case where, for example, the user being in a private location such as a restaurant and an accommodation facility has been recognized, the control unit 150 may perform control to bring the positional information protection level into the middle level, and make accuracy in acquiring the positional information about 100 km, or make a frequency of updating the positional information about 15 minutes.

Furthermore, in a case where, for example, a person other than the user or the user's close relatives being about to be notified of the positional information has been recognized, the control unit 150 may perform control to bring the positional information protection level into the low level, and make accuracy in acquiring the positional information about 1 km, or make a frequency of updating the positional information about 5 minutes.

<<1.4 User Identification During Execution of Image Protection Mode>>

Subsequently, a user identification method during execution of the image protection mode according to the present embodiment will be described. In a case where the information processing device 10 includes both the imaging unit 110 and the voice input unit 120, facial identification using an image is typically used for user identification in many cases.

However, since the image acquisition function is restricted during execution of the image protection mode according to the present embodiment, user identification by an image as is performed in the normal mode is difficult.

Thus, the recognition unit 140 according to the present embodiment may be capable of dynamically switching the user identification method on the basis of a mode being executed.

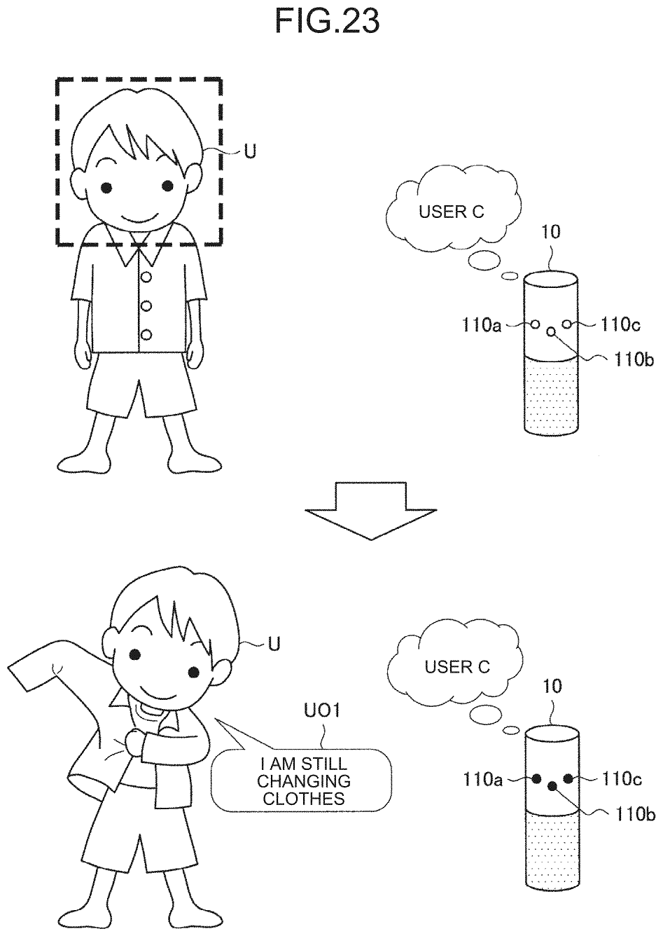

FIG. 23 is a diagram for explaining switching of a user identification method based on an execution mode according to the present embodiment. The upper part of FIG. 23 illustrates the user U in the normal state (state of not performing protection target act).

At this time, the control unit 150 according to the present embodiment sets the normal mode, and the recognition unit 140 extracts a facial feature amount from an image acquired by the image acquisition function on which no restriction is imposed and compares the facial feature amount with a facial feature amount of the user registered in advance to identify the user.

In contrast, the lower part of FIG. 23 illustrates the user U performing the act of changing clothes. At this time, the control unit 150 according to the present embodiment sets the image protection mode, and the recognition unit 140 can identify the user by extracting a vocal feature amount from an utterance UO1 of the user and comparing the vocal feature amount with a vocal feature amount of the user registered in advance.

In this manner, with the recognition unit 140 according to the present embodiment, the user identification method can be dynamically switched in accordance with a mode being executed, and the user can be recognized at high accuracy even during execution of the image protection mode.

Note that a gap of the registered vocal feature amount from the vocal feature amount of the user at the present time widens due to aging degradation, change in environment, and/or the like, so that the vocal feature amount is preferably registered frequently to achieve identification of a speaker at high accuracy.

However, the registration of the vocal feature amount is a burdensome work to the user, and thus is preferably automatically performed whenever possible.

Thus, the recognition unit 140 according to the present embodiment may have a function of automatically acquiring a feature amount used for user identification and updating the feature amount. Specifically, the recognition unit 140 according to the present embodiment may automatically extract and update the vocal feature amount even in a case where the user identification is performed on the basis of the facial feature amount at the time of execution of the normal mode.

With the above-described functions of the recognition unit 140 according to the present embodiment, the vocal feature amount automatically acquired and updated in the normal mode can be used in the image protection mode, and identification of the speaker at high accuracy can be achieved. Note that the recognition unit 140 according to the present embodiment may automatically acquire and update the facial feature amount in addition to the vocal feature amount. As described above, with the recognition unit 140 according to the present embodiment, the user can be identified at high accuracy even in a case where the image acquisition function is restricted.

<2. Exemplary Hardware Configuration>

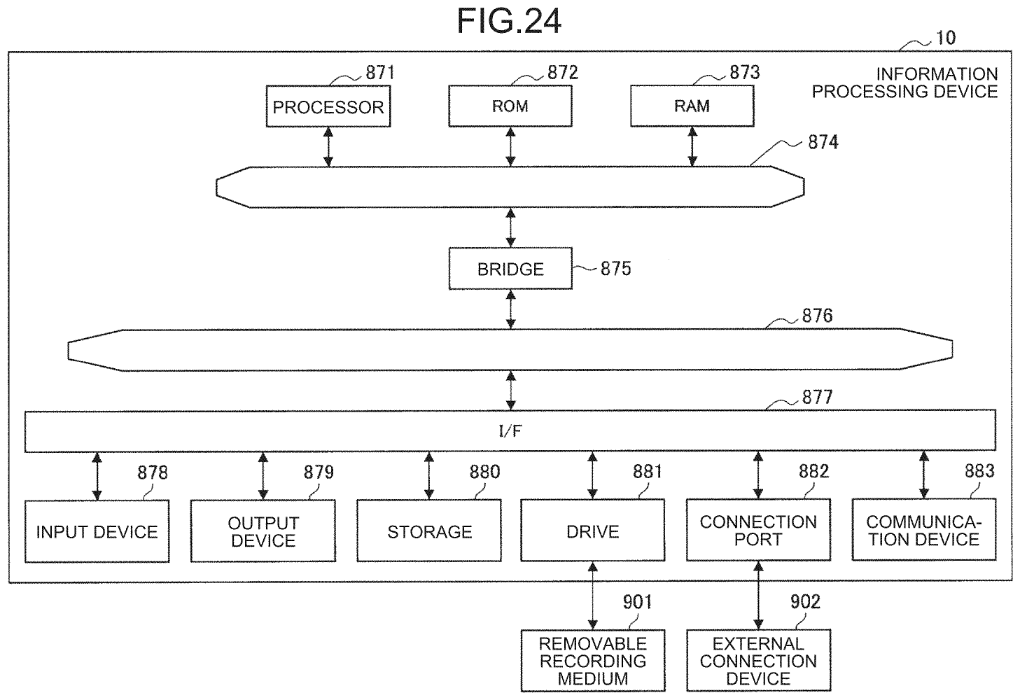

An example of the hardware configuration common to the information processing device 10 according to an embodiment of the present disclosure is now described. FIG. 24 is a block diagram illustrating an example of the hardware configuration of the information processing device 10 according to an embodiment of the present disclosure. Referring to FIG. 24, the information processing device 10 includes, in one example, a processor 871, a ROM 872, a RAM 873, a host bus 874, a bridge 875, an external bus 876, an interface 877, an input device 878, an output device 879, a storage 880, a drive 881, a connection port 882, and a communication device 883. Note that the hardware configuration illustrated here is an example, and some of the components may be omitted. In addition, components other than the components illustrated herein may be further included.

(Processor 871)

For example, the processor 871 functions as an arithmetic processing device or a control device, and controls an overall operation of each component or a part thereof based on various programs recorded in the ROM 872, the RAM 873, the storage 880 or a removable recording medium 901.

(ROM 872, RAM 873)

The ROM 872 is a means to store a program read by the processor 871, data used for calculations, or the like. The RAM 873 temporarily or permanently stores, for example, the program read by the processor 871, various parameters that change as appropriate when the program is executed, or the like.

(Host Bus 874, Bridge 875, External Bus 876, and Interface 877)

The processor 871, the ROM 872, and the RAM 873 are mutually connected via, for example, the host bus 874 capable of high-speed data transmission. Meanwhile, the host bus 874 is connected to the external bus 876, which has a relatively low data transmission rate, via the bridge 875 for example. In addition, the external bus 876 is connected to various components via the interface 877.

(Input Device 878)

As the input device 878, for example, a mouse, a keyboard, a touch panel, a button, a switch, a lever, or the like are used. Further, a remote controller (hereinafter, remote controller) capable of transmitting a control signal using infrared rays or other radio waves may be also used as the input device 878. In addition, the input device 878 also includes a speech input device such as a microphone.

(Output Device 879)

The output device 879 is a device capable of visually or audibly notifying acquired information to a user, for example, a display device such as Cathode Ray Tube (CRT), LCD, and organic EL, an audio output device such as a speaker and a headphone, a printer, a mobile phone, a facsimile, or the like. In addition, the output device 879 according to the present disclosure includes various vibration devices capable of outputting haptic stimulation.

(Storage 880)

The storage 880 is a device configured to store various types of data. As the storage 880, for example, a magnetic storage device such as a hard disk drive (HDD), a semiconductor storage device, an optical storage device, a magneto-optical storage device, or the like is used.

(Drive 881)

The drive 881 is a device that reads information recorded on the removable recording medium 901 such as a magnetic disk, an optical disk, a magneto-optical disk, and a semiconductor memory, or writes information to the removable recording medium 901.

(Removable Recording Medium 901)

The removable recording medium 901 is, for example, a DVD medium, a Blu-ray (registered trademark) medium, an HD DVD medium, various semiconductor storage media, or the like. It is a matter of course that the removable recording medium 901 may be, for example, an IC card equipped with a non-contact IC chip, an electronic device, or the like.

(Connection Port 882)

The connection port 882 is a port configured to connect an external connection device 902, for example, a universal serial bus (USB) port, an IEEE 1394 port, a small computer system interface (SCSI), an RS-232C port, an optical audio terminal, or the like.

(External Connection Device 902)

The external connection device 902 is, for example, a printer, a portable music player, a digital camera, a digital video camera, an IC recorder, or the like.

(Communication Device 883)

The communication device 883 is a communication device configured for connection to a network and is, for example, a wired or wireless LAN, a communication card for Bluetooth (registered trademark) or a wireless USB (WUSB), a router for optical communication, a router for an asymmetric digital subscriber line (ADSL), or a modem for various communications.

<3. Summary>

As described above, the information processing device 10 according to an embodiment of the present disclosure includes the control unit 150 that controls the information acquisition function to acquire information regarding the state of the user. Furthermore, one of characteristics of the control unit 150 according to an embodiment of the present disclosure lies in controlling a transition to the information protection mode that restricts at least part of the information acquisition function on the basis of the start of the protection target act by the user having been estimated. With this configuration, psychological anxiety of the user regarding acquisition of information in utilizing agent functions can be reduced.

As described above, the favorable embodiments of the present disclosure have been described in detail with reference to the accompanying drawings, but the technical scope of the present disclosure is not limited to such examples. It is obvious that persons having ordinary knowledge in the technical field of the present disclosure can conceive various changes and alterations within the scope of the technical idea described in the claims, and it is naturally understood that these changes and alterations belong to the technical scope of the present disclosure.

Furthermore, the effects described in the present specification are merely illustrative or exemplary and are not restrictive. That is, the technology according to the present disclosure can exhibit other effects obvious to those skilled in the art from the description of the present specification in addition to or in place of the above-described effects.

Further, it is also possible to create a program for causing hardware such as a processor, a memory, and a storage incorporated into a computer to exert a function equivalent to the structural elements included in the above-described information processing device 10, in addition, it is also possible to provide a computer readable storage medium in which the program is recorded.

Further, the respective steps in the processing of the information processing device 10 in this specification are not necessarily executed in chronological order in accordance with the order illustrated in the flowcharts. In one example, the respective steps in the processing of the information processing device 10 can be processed in the order different from the order illustrated in the flowcharts, or can also be processed in parallel.

Additionally, the following configurations also belong to the technical scope of the present disclosure.
(1)

An information processing device comprising

a control unit that controls an information acquisition function to acquire information regarding a state of a user,

wherein the control unit controls a transition to an information protection mode that restricts at least part of the information acquisition function on the basis of a start of a protection target act by the user having been estimated.
(2)

The information processing device according to (1),

wherein the control unit controls the information acquisition function in the information protection mode such that accuracy in acquiring information regarding the protection target act decreases.
(3)

The information processing device according to (2), wherein

the control unit performs control to decrease the accuracy in acquiring the information regarding the protection target act in the information protection mode to an extent that at least one of the protection target act or the user cannot be identified.
(4)

The information processing device according to (1), wherein

the control unit performs control to stop acquisition of information regarding the protection target act in the information protection mode.
(5)

The information processing device according to any one of (1) to (4), wherein

the control unit determines a restricted content of the information acquisition function on the basis of a protection level of the protection target act in the information protection mode.
(6)

The information processing device according to any one of (1) to (5), wherein

the control unit controls a return to a normal mode that does not restrict the information acquisition function in the information protection mode on the basis of an end of the protection target act having been estimated.
(7)

The information processing device according to any one of (1) to (6), wherein

the information acquisition function includes at least one of an image acquisition function, a voice acquisition function, or a positional information acquisition function.
(8)

The information processing device according to any one of (1) to (7), wherein

the information protection mode includes an image protection mode, and

the control unit controls a transition to the image protection mode on the basis of the start of the protection target act having been estimated, and restricts at least part of an image acquisition function in the image protection mode.
(9)

The information processing device according to (8), wherein

the protection target act includes at least an act of changing clothes by the user, and

the control unit restricts, on the basis of a start of the act of changing clothes having been estimated, the image acquisition function to an extent that at least one of the act of changing clothes or the user cannot be identified.
(10)

The information processing device according to any one of (1) to (9), wherein

the information protection mode includes a voice protection mode, and

the control unit controls a transition to the voice protection mode on the basis of the start of the protection target act having been estimated, and restricts at least part of a voice acquisition function in the voice protection mode.
(11)

The information processing device according to (10), wherein

the protection target act includes a protection target utterance by the user, and

the control unit restricts, on the basis of a start of the protection target utterance having been estimated, at least part of the voice acquisition function to an extent that a content of the protection target utterance cannot be identified.
(12)

The information processing device according to any one of (1) to (11), wherein

the information protection mode includes a positional information protection mode, and

the control unit controls a transition to the positional information protection mode on the basis of the start of the protection target act having been estimated, and restricts at least part of a positional information acquisition function in the positional information protection mode.
(13)

The information processing device according to (12), wherein

the protection target act includes a stay of the user in a protection target area, and

the control unit restricts, on the basis of a start of the stay of the user in the protection target area having been estimated, at least part of the positional information acquisition function to an extent that the protection target area cannot be identified.
(14)

The information processing device according to any one of (1) to (13), wherein

the control unit controls an exhibition regarding execution of the information protection mode in the information protection mode.
(15)

The information processing device according to (14), wherein

the control unit performs control to notify the user of the information protection mode being executed by using a voice or visual information in the information protection mode.
(16)

The information processing device according to (14) or (15), wherein

the control unit performs control to express that the information protection mode is being executed by a physical motion in the information protection mode.
(17)

The information processing device according to any one of (1) to (16), further comprising

a recognition unit that estimates the start or an end of the protection target act on the basis of the information regarding the state of the user.
(18)

The information processing device according to (17), wherein

the recognition unit estimates the end of the protection target act on the basis of information acquired by a remaining function of the information acquisition
(19)

The information processing device according to (17) or (18), wherein

the recognition unit detects the start or the end of the protection target act on the basis of an instruction of the user.
(20)

An information processing method comprising

controlling an information acquisition function by a processor to acquire information regarding a state of a user,

wherein the controlling further includes

controlling a transition to an information protection mode that restricts at least part of the information acquisition function on the basis of a start of a protection target act by the user having been estimated.

### REFERENCE SIGNS LIST

10 Information processing device

110 Imaging unit

120 Voice input unit

130 Sensor unit

140 Recognition Unit

150 Control unit

160 Display unit

170 Voice output unit

1. An information processing device comprising
a control unit that controls an information acquisition function to acquire information regarding a state of a user,
wherein the control unit controls a transition to an information protection mode that restricts at least part of the information acquisition function on the basis of a start of a protection target act by the user having been estimated.

2. The information processing device according to claim 1,
wherein the control unit controls the information acquisition function in the information protection mode such that accuracy in acquiring information regarding the protection target act decreases.

3. The information processing device according to claim 2, wherein
the control unit performs control to decrease the accuracy in acquiring the information regarding the protection target act in the information protection mode to an extent that at least one of the protection target act or the user cannot be identified.

4. The information processing device according to claim 1, wherein
the control unit performs control to stop acquisition of information regarding the protection target act in the information protection mode.

5. The information processing device according to claim 1, wherein
the control unit determines a restricted content of the information acquisition function on the basis of a protection level of the protection target act in the information protection mode.

6. The information processing device according to claim 1, wherein
the control unit controls a return to a normal mode that does not restrict the information acquisition function in the information protection mode on the basis of an end of the protection target act having been estimated.

7. The information processing device according to claim 1, wherein
the information acquisition function includes at least one of an image acquisition function, a voice acquisition function, or a positional information acquisition function.

8. The information processing device according to claim 1, wherein
the information protection mode includes an image protection mode, and
the control unit controls a transition to the image protection mode on the basis of the start of the protection target act having been estimated, and restricts at least part of an image acquisition function in the image protection mode.

9. The information processing device according to claim 8, wherein
the protection target act includes at least an act of changing clothes by the user, and
the control unit restricts, on the basis of a start of the act of changing clothes having been estimated, the image acquisition function to an extent that at least one of the act of changing clothes or the user cannot be identified.

10. The information processing device according to claim 1, wherein
the information protection mode includes a voice protection mode, and
the control unit controls a transition to the voice protection mode on the basis of the start of the protection target act having been estimated, and restricts at least part of a voice acquisition function in the voice protection mode.

11. The information processing device according to claim 10, wherein
the protection target act includes a protection target utterance by the user, and
the control unit restricts, on the basis of a start of the protection target utterance having been estimated, at least part of the voice acquisition function to an extent that a content of the protection target utterance cannot be identified.

12. The information processing device according to claim 1, wherein
the information protection mode includes a positional information protection mode, and
the control unit controls a transition to the positional information protection mode on the basis of the start of the protection target act having been estimated, and restricts at least part of a positional information acquisition function in the positional information protection mode.

13. The information processing device according to claim 12, wherein
the protection target act includes a stay of the user in a protection target area, and
the control unit restricts, on the basis of a start of the stay of the user in the protection target area having been estimated, at least part of the positional information acquisition function to an extent that the protection target area cannot be identified.

14. The information processing device according to claim 1, wherein
the control unit controls an exhibition regarding execution of the information protection mode in the information protection mode.

15. The information processing device according to claim 14, wherein
the control unit performs control to notify the user of the information protection mode being executed by using a voice or visual information in the information protection mode.

16. The information processing device according to claim 14, wherein
the control unit performs control to express that the information protection mode is being executed by a physical motion in the information protection mode.

17. The information processing device according to claim 1, further comprising
a recognition unit that estimates the start or an end of the protection target act on the basis of the information regarding the state of the user.

18. The information processing device according to claim 17, wherein
the recognition unit estimates the end of the protection target act on the basis of information acquired by a remaining function of the information acquisition function in the information protection mode.

19. The information processing device according to claim 17, wherein
the recognition unit detects the start or the end of the protection target act on the basis of an instruction of the user.

20. An information processing method comprising
controlling an information acquisition function by a processor to acquire information regarding a state of a user,
wherein the controlling further includes
controlling a transition to an information protection mode that restricts at least part of the information acquisition function on the basis of a start of a protection target act by the user having been estimated.
